(19) United States
(12) Patent Application Publication
(10) Pub. No.: US 2018/0102077 A1
(43) Pub. Date: Apr. 12, 2018

(54) TRANSPARENT DISPLAY METHOD AND TRANSPARENT DISPLAY DEVICE

(71) Applicant: BOE Technology Group Co., Ltd., Beijing (CN)

(72) Inventor: She Lin, Beijing (CN)

(21) Appl. No.: 15/519,894

(22) PCT Filed: Jul. 25, 2016
(86) PCT No.: PCT/CN2016/091504

§ 371 Date: Apr. 18, 2017

(30) Foreign Application Priority Data
Mar. 18, 2016 (CN) 201610159083.8

(51) Int. Cl. G09G 3/00; G02B 27/14

(52) U.S. Cl. CPC G09G 3/00; H04N 13/0459; G02B 27/144; H04N 13/0413; H04N 13/049

(57) ABSTRACT

A transparent display method and transparent display device are disclosed. The transparent display method includes: obtaining a spatial position of eyes of a viewer at a side of a display screen with respect to the display screen; obtaining a spatial position of at least one key point of an object at the other side of the display screen with respect to the display screen; calculating a projection position of the at least one key point on the display screen with respect to the viewer's eyes in accordance with the spatial position of the viewer's eyes with respect to the display screen and the spatial position of the at least one key point with respect to the display screen; and adjusting an image displayed on the display screen in accordance with the projection position.

### CROSS-REFERENCE TO RELATED APPLICATIONS

The present application is based upon International Application No. PCT/CN2016/091504, filed on Jul. 25, 2016, which is based upon claims priority to Chinese Patent Application No. 201610159083.8, filed Mar. 18, 2016, the entire contents of which are incorporated herein by reference.

### TECHNICAL FIELD

The present disclosure relates to the field of display technology, and more particularly, to a transparent display method and a transparent display device.

### BACKGROUND

In a related art, a transparent display device may be placed in front of an actual object to enhance expression by displaying an image corresponding to the actual object. For example, the transparent display may be disposed in front of an exhibition cabinet of a building model, and a site name corresponding to each position of the building model may be displayed on the transparent display, such that a viewer can view the site name on the building model marked by the transparent display while viewing the building model, greatly enhancing the exhibition results.

However, since the transparent display device has a certain distance from the rear actual object, the content displayed on the transparent display device will not match the actual object if the viewer changes his viewing position. For example, the marked position of the site will be offset on the building model, affecting the actual display effect.

It should be noted that, information disclosed in the above background portion is provided only for better understanding of the background of the present disclosure, and thus it may contain information that does not form the prior art known by those skilled in the art.

### SUMMARY

The present disclosure provides a transparent display method and a transparent display device.

In a first aspect, the present disclosure provides a transparent display method, comprising:

obtaining a spatial position of eyes of a viewer at a side of a display screen with respect to the display screen;

obtaining a spatial position of at least one key point of an object at the other side of the display screen with respect to the display screen;

calculating a projection position of the at least one key point on the display screen with respect to the viewer's eyes in accordance with the spatial position of the viewer's eyes with respect to the display screen and the spatial position of the at least one key point with respect to the display screen; and

adjusting an image displayed on the display screen in accordance with the projection position.

In a second aspect, the present disclosure further provides a transparent display device, comprising:

a first obtaining unit configured to obtain a spatial position of eyes of a viewer at a side of a display screen with respect to the display screen;

a second obtaining unit configured to obtain a spatial position of at least one key point of an object at the other side of the display screen with respect to the display screen;

a calculation unit configured to calculate a projection position of the at least one key point on the display screen with respect to the viewer's eyes in accordance with the spatial position of the viewer's eyes with respect to the display screen and the spatial position of the at least one key point with respect to the display screen; and

an adjustment unit configured to adjust an image displayed on the display screen in accordance with the projection position.

The present disclosure also provides a transparent display method, comprising:

obtaining a first spatial position of eyes of a first viewer at a first side of a display screen with respect to the display screens and a second spatial position of eyes of a second viewer at the first side of the display screen with respect to the display screen;

obtaining a spatial position of at least one key point of an object at the other side of the display screen with respect to the display screen;

calculating a first projection position of the at least one key point on the display screen with respect to the first viewer's eyes in accordance with the first spatial position and the spatial position of the at least one key point with respect to the display screen, and calculating a second projection position of the at least one key point on the display screen with respect to the second viewer's eyes in accordance with the second spatial position and the spatial position of the at least one key point with respect to the display screen; and

adjusting a first image displayed for the first viewer on the display screen in accordance with the first projection position, and adjusting a second image displayed for the second viewer on the display screen in accordance with the second projection position.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

In order to more clearly illustrate the technical solutions in embodiments of the present disclosure or in the prior art, the following drawings to be used in the description of the embodiments or in the prior art will be briefly introduced below. Apparently, the drawings in the following description are only for some embodiments of the disclosure, those of ordinary skill in the art may also obtain other drawings from these drawings, without creative efforts.

FIG. 1 is a schematic flow diagram of a transparent display method according to one embodiment of the present disclosure;

FIG. 2 is a schematic principle diagram of a transparent display method according to one embodiment of the present disclosure;

FIG. 3 is another schematic principle diagram of a transparent display method according to one embodiment of the present disclosure;

FIG. 4 is a schematic diagram of a capturing principle of a transparent display device in a side view according to one embodiment of the present disclosure;

FIG. 5 is a schematic flow diagram of steps of calculating a position of a projection point according to one embodiment of the present disclosure; and

FIG. 6 is a structural block diagram of a transparent display device according to one embodiment of the present disclosure.

### DETAILED DESCRIPTION

In order to make the objects, technical solutions and advantages of the embodiments of the present disclosure to be more apparent, the technical solutions in the embodiments of the present disclosure will be clearly and completely described in combination with the drawings in the embodiments of the present invention. Apparently, the described embodiments are merely part of the embodiments and not all of the embodiments. All other embodiments obtained by those of ordinary skill in the art without making creative work are within the scope of the present disclosure, based on the embodiments of the present disclosure.

FIG. 1 is a schematic flow diagram of a transparent display method according to one embodiment of the present disclosure. Referring to FIG. 1, the transparent display method of an embodiment of the present disclosure comprises:

step 101: obtaining a spatial position of eyes of a viewer at a side of a display screen with respect to the display screen;

step 102: obtaining a spatial position of at least one key point of an object at the other side of the display screen with respect to the display screen;

step 103: calculating a projection position of the at least one key point on the display screen with respect to the viewer's eyes in accordance with the spatial position of the viewer's eyes with respect to the display screen and the spatial position of the at least one key point with respect to the display screen; and

step 104: adjusting an image displayed on the display screen in accordance with the projection position.

It should be noted that steps 101 and 102 in the present disclosure may be executed at the same time, or may be executed in sequence, which is not limited herein. Moreover, the transparent display method of embodiments of the present disclosure is applicable to any kind of the transparent display device comprising a display screen, and the viewer in front of the display screen (corresponding to “a side of a display screen” described as above, i.e. at a front side) may view the image displayed on the display screen, and also view the object at the rear of the display screen (corresponding to “the other side of the display screen” described as above, i.e. at a rear side) through the display screen.

In the above step 101, the obtaining of the spatial position of the viewer's eyes with respect to the display screen may be, for example, an eye recognition and a spatial position measurement of an image captured in front of the display screen, or a signal input of an external device having a function of measuring the spatial position of the viewer's eyes. It is to be understood that the spatial position of the viewer's eyes refers to its relative position with respect to the display screen, which may be represented by a three-dimensional coordinate, or may be represented by an azimuth and a distance, and also may be represented by other coordinate systems. The spatial position of the viewer's eyes may be the spatial position of a center of the eyes, or the spatial position of each of the eyes, which is not limited herein.

As an example, the process of obtaining the spatial position of the viewer's eyes with respect to the display screen by identifying the viewer's eyes in the captured image may comprise a process of recognizing human eyes feature in the captured image and a process of measuring the distance between human eyes and the display screen in the captured image. One of the implementations is to capture the viewer in front of the display screen by a camera module fixed at a preset position of the display screen to determine in the captured image the spatial position of the viewer's eyes with respect to the display screen.

For example, the camera module captures the front of the display in real time at a predetermined position and viewing angle, and performs face detection according to the face feature in the captured image, to lock the detected face and track it. In the tracked face area, according to the structure, shape, gray scale and other characteristics of human eyes, a position of the viewer's eyes is positioned, and pupil parameters of human eyes are estimated. According to the positioned coordinate, shape structure and other characteristics of the human eye pupil in the space and the image, the spatial position of the viewer's eyes with respect to the display screen is estimated in real time, which is used as a reference for adjusting the image displayed on the display screen.

In the above step 102, the object at the other side of the display screen may be disposed in advance to have a predetermined relative positional relationship with the display screen, such that the spatial position of at least one key point on the object relative to the display screen can be obtained based on the position information of the object acquired in advance. For example, the spatial location of the at least one key may be obtained from a pre-stored database or a pre-stored digital model of an object. For example, the position information of the object may be stored in a transparent display device together with distance information in a form of a three-dimensional digital model, such that the spatial location of the selected key point can be obtained through calculation in conjunction with the three-dimensional digital model and the distance information. As another example, the spatial location of the at least one key may also be derived from an external input of a third-party device (such as a central computer or a network server that manages the three-dimensional digital model of the object). Of course, it is also possible to obtain the spatial position of the at least one key point on the object based on image processing in a manner similar to determining the spatial position of the human eyes, and the embodiments of the present disclosure are not limited herein.

In the above step 103, the position of the projection point of at least one key point on the plane where the display screen is located with respect to the viewer's eyes may be obtained by an operation of spatial geometry in the same coordinate system based on the spatial position of the viewer's eyes and the spatial position of at least one key point. In the above step 104, the image to be displayed on the display screen is adaptively adjusted based on the position of the projection point of at least one key point on the plane where the display screen is located with respect to the viewer's eyes. For example, since the position of the image of the object viewed by the human eyes on the plane where the display screen is located has been determined, at least one graphic in the image to be displayed may be translated, rotated, enlarged, reduced, redrawn, divided, removed and added to match the image of the object. It is to be understood that the determination of the projection point may be achieved under same geometrical principle with different calculations, and in a specific application scenario, the specific way of adjustment may be selected according to different display effects that the transparent display device needs to present, while the embodiments of the present disclosure are not limited thereto.

It can be seen that, in the embodiments of the present disclosure, based on the steps 101-104 described as above, the projection point of each key point on the object on the plane where the display screen is located is calculated according to the spatial position of the viewer's eyes and the spatial position of the object, and the displayed image is adjusted based on the position of the projection point, which may solve the problem that the image displayed by the transparent display device may not match the rear actual object after the viewer changes the viewing position. Compared with the related art, the embodiments of the present disclosure can not only guarantee the matching of the displayed image with the actual object, but also realize various display effects with the movement of the human eyes, and greatly enhance the exhibition effect.

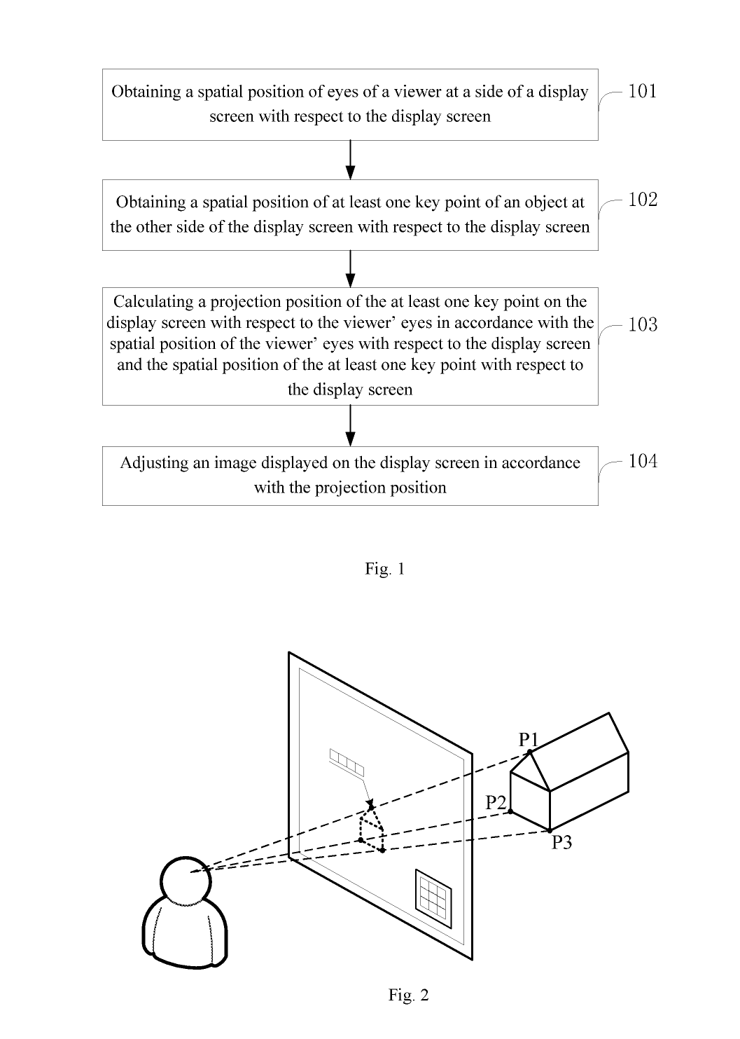

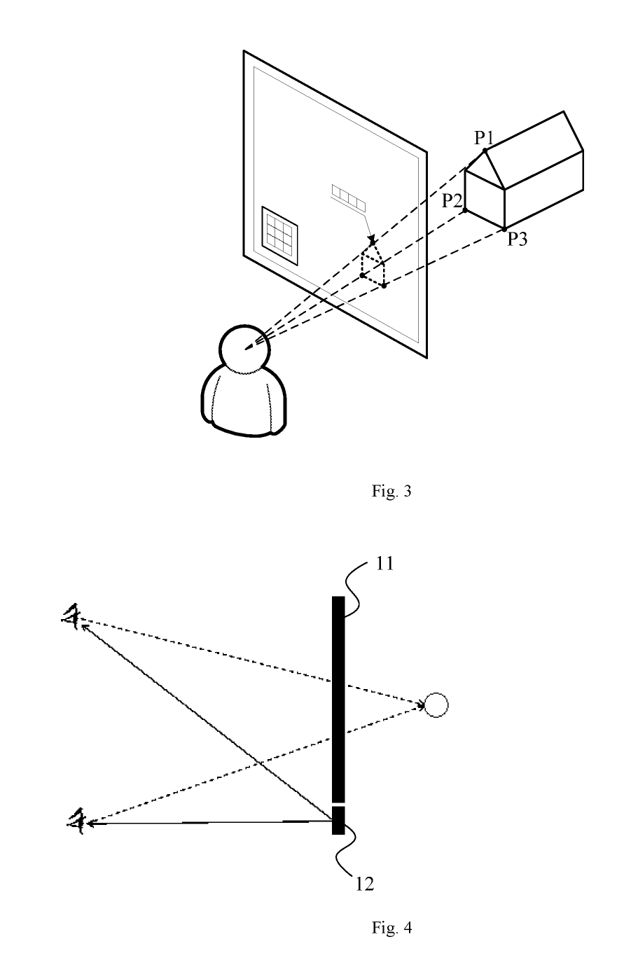

As a specific example, FIGS. 2 and 3 are schematic principle diagrams of a transparent display method according to one embodiment of the present disclosure. Referring to FIGS. 2 and 3, FIGS. 2 and 3 respectively show images displayed by the transparent display device when the viewer is located at a first viewing position and a second viewing position. In particular, in step 101, the transparent display device obtains the spatial position of the viewer's eyes. In step 102, the transparent display device obtains spatial positions of three key points P1, P2, and P3 on a building model. Therefore, in step 103, three projection points of the three key points P1, P2 and P3 on a plane where the display screen is located with respect to the viewer's eyes are determined in a way shown by the dotted line in the drawing, and in step 104, one marked graphic and one text box graphic in the image to be displayed are adjusted according to positions of the three projection points on the plane where the display screen is located.

It can be seen that, a position pointed by an arrow of the marked graphic corresponds to the key point P1 on the building model, that is, the marked graphic is intended to identify the specific structure or position of the building model. The text box graphic is located at the bottom of the image to be displayed, and is intended to illustrate the entire building model. However, it will be understood that, if the viewer moves from the first viewing position to the second viewing position, and the transparent display device still displays the picture as shown in FIG. 2 based on the related art, it is obvious that the position pointed by the arrow of the marked graphic may be separated and dislocated from the key point P1 on the building model, and the text box graphic may also be overlapped with the image of the building model in human eyes, causing visual confusion.

However, in the embodiment of the present disclosure, the transparent display device tracks the position of the projection point of the key point P1 between the first viewing position and the second viewing position, and translates the marked graphic, such that the position pointed by its arrow still corresponds to the key point P1 on the building model. Therefore, in the eyes of a moving human, the arrow of the marked graphic on the plane where the display screen is located always points to the key point P1 of the building model, such that the marking role of the marked graphic may be maintained. On this basis, the transparent display device can also adjust the size of the marked graphic according to a distance of the viewer from the display screen, such that the position of the marked graphic viewed by the viewer's eyes is constant in the space. For the text box graphic, the transparent display device removes the text box graphic from the lower right corner of the picture, and adds a text box graphic having the same meaning of indication in the lower left corner of the picture, thereby avoiding the situation where the text box graphic overlaps with the building model in human eyes.

Further, the way of adjusting at least one graphic in the image in the above step 104 may include, but not be limited to, at least one of translation, rotation, enlargement, reduction, redrawing, segmentation, deletion and addition. In one embodiment, the translation of the graphic may realize the tracking of the key point on the object by a plane graphic, as exemplified above for the marked graphic. The enlargement and reduction of the graphic may achieve a stereoscopic effect of foreshortening, as exemplified above. The redrawing of the graphic may be used to show stereoscopic graphics under different perspectives. The deletion and addition of the graphic may avoid the situation where the shown graphic overlaps with the object in human eyes, as exemplified above for the text box graphic, and may also achieve the animation effect of different pictures at different viewing angles and distances. In addition, the adjusting for various images described as above may achieve the desired display effect by various combinations, and the embodiment of the present disclosure is not limited herein.

As an example of obtaining a spatial position of eyes of a viewer at a side of a display screen with respect to the display screen, FIG. 4 is a schematic diagram of a capturing principle of a transparent display device in a side view according to one embodiment of the present disclosure. As shown in this drawing, the transparent display device comprises a display panel 11 and a camera module disposed under the display panel 11, and the camera module 12 is disposed at a fixed position relative to the display screen, such that the image captured at a first display side in the above step 101 may be obtained by the camera module 12 having a capturing direction toward the first display side. However, it will be understood that the disposed position of the camera module shown in FIG. 4 is only an example. Except that the camera module is disposed under the display panel 11, it can also disposed at any preset position which is relatively fixed with respect to the display screen, and in this case, the image captured at a first display side can be similarly obtained and the camera module may be also used to obtain the spatial position of the viewer's eyes.

As an example of calculating the position of the projection point on the plane where the display screen is located, FIG. 5 is a schematic flow diagram of steps of calculating the position of the projection point according to one embodiment of the present disclosure. Referring to FIG. 5, the above step 103 of calculating a projection position of the at least one key point on the display screen with respect to the viewer's eyes in accordance with the spatial position of the viewer's eyes with respect to the display screen and the spatial position of the at least one key point with respect to the display screen may particularly comprise following steps.

In step 501, the spatial position of the viewer's eyes with respect to the display screen, the spatial position of the at least one key point with respect to the display screen and a plane where the display screen is located are mapped into the same spatial coordinate system.

In step 502, an intersection position of a line connecting each of the at least one key point with the viewer's eyes and the plane where the display screen is located is calculated in spatial coordinate system to obtain at least one projection point.

In step 503, a position of the at least one projection point in the spatial coordinate system is transformed into a position on the plane where the display screen is located, to be used as the projection position.

For example, referring to FIGS. 2 and 3, the above step 501 may comprise mapping the spatial positions of the key points P1, P2 and P3 and the spatial position of the viewer's eyes obtained in step 101 into an X-Y-Z space rectangular coordinate system having a Y-Z plane which is the plane where the display screen is located. Therefore, the above step 502 may comprise respectively calculating an expression of lines (i.e., three dotted lines shown in FIGS. 2 and 3) connecting the key points P1, P2 and P3 with the viewer's eyes in the above X-Y-Z space rectangular coordinate system, and obtaining the positions of the three projection points in the X-Y-Z space rectangular coordinate system by calculating intersection positions of the lines with the Y-Z plane which is the plane where the display screen is located. Based on this, the above step 503 may comprise transforming the positions of the three projection points in the X-Y-Z space rectangular coordinate system into a Y-Z coordinate system having the plane where the display screen is located, such that the positions of the three projection points in a plane where the display screen is located are obtained.

It can be seen that, the embodiment of the present disclosure may obtain the projection position of the object on the plane where the display screen is located with respect to human eyes by the calculations of the steps 501 to 503 based on the spatial position of the viewer's eyes, the spatial position of at least one key point and the spatial position of the plane where the display screen is located, and is adapted to be implemented by a calculation program or a circuit configuration having a calculation function.

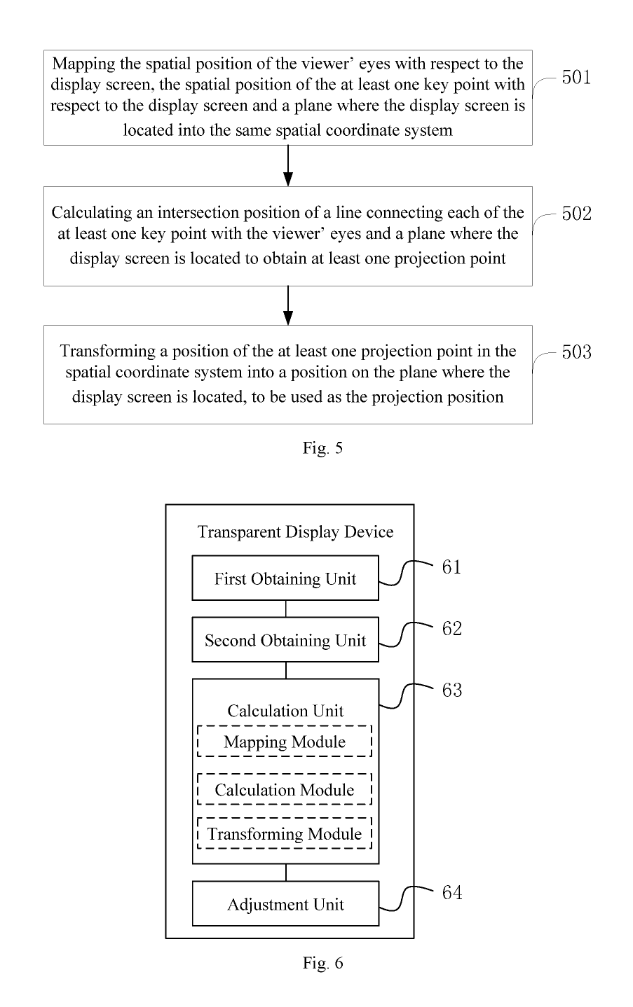

Based on the same inventive concept, FIG. 6 is a structural block diagram of a transparent display device according to one embodiment of the present disclosure. Referring to FIG. 6, the transparent display device of the embodiment of the present disclosure comprises:

a first obtaining unit 61 configured to obtain a spatial position of eyes of a viewer at a side of a display screen with respect to the display screen;

a second obtaining unit 62 configured to obtain a spatial position of at least one key point of an object at the other side of the display screen with respect to the display screen;

a calculation unit 63 configured to calculate a projection position of the at least one key point on the display screen with respect to the viewer's eyes in accordance with the spatial position of the viewer's eyes with respect to the display screen and the spatial position of the at least one key point with respect to the display screen; and

an adjustment unit 64 configured to adjust an image displayed on the display screen in accordance with the projection position.

It can be seen that, in the embodiment of the present disclosure, based on the structure shown in FIG. 6, the projection points of the respective key points of the object on the plane where the display screen is located may be calculated based on the spatial position of the viewer's eyes and the spatial position of the object, and the displayed image is adjusted according to the positions of the projection points, which may solve the problem that the image displayed by the transparent display device does not match the rear actual object after the viewer changes the viewing position. Compared with the related art, the embodiment of the present disclosure can not only guarantee the matching of the displayed image with the actual object, but also realize various display effects with the movement of human eyes, and greatly enhance the exhibition effect.

As an example of calculating the position of the projection position on the plane where the display screen is located, the above calculation unit 63 may particularly comprise:

a mapping module configured to map the spatial position of the viewer's eyes with respect to the display screen, the spatial position of the at least one key point with respect to the display screen and a plane where the display screen is located into the same spatial coordinate system;

a calculation module configured to calculate an intersection position of a line connecting each of the at least one key point with the viewer's eyes and a plane where the display screen is located to obtain at least one projection point; and

a transforming module configured to transform a position of the at least one projection point in the spatial coordinate system into a position on the plane where the display screen is located, to be used as the projection position.

For example, referring to FIGS. 2 and 3, the above mapping module may be particularly configured to map the spatial positions of the key points P1, P2 and P3 and the spatial position of the viewer's eyes obtained in the first obtaining unit 11 into an X-Y-Z space rectangular coordinate system having a Y-Z plane which is the plane where the display screen is located. Therefore, the above calculation module may be particularly configured to respectively calculate an expression of lines (i.e., three dotted lines shown in FIGS. 2 and 3) of connecting the key points P1, P2 and P3 with the viewer's eyes in the above X-Y-Z space rectangular coordinate system, and obtaining the positions of the three projection points in the X-Y-Z space rectangular coordinate system by calculating intersection positions of the lines with the Y-Z plane which is the plane where the display screen is located. Based on this, the above transforming module may be particularly configured to transform the positions of the three projection points in the X-Y-Z space rectangular coordinate system into a Y-Z coordinate system having the plane where the display screen is located, such that the positions of the three projection points in a plane where the display screen is located are obtained.

It can be seen that, the embodiment of the present disclosure may obtain the projection position of the object on the plane where the display screen is located with respect to human eyes by the calculation of the calculation unit 63 based on the spatial position of the viewer's eyes, the spatial position of at least one key point and the spatial position of the plane where the display screen is located, and is adapted to be implemented by a calculation program or a circuit configuration having a calculation function.

Further, the above adjustment unit 64 may be particularly configured to adjust at least one graphic in current image in accordance with the projection position, wherein the adjustment of the at least one graphic comprises at least one of translation, rotation, enlargement, reduction, redrawing, segmentation, deletion and addition. In one embodiment, the translation of the graphic may realize the tracking of the key point on the object by a plane graphic, as exemplified above for the marked graphic. The enlargement and reduction of the graphic may achieve a stereoscopic effect of foreshortening, as exemplified above. The redrawing of the graphic may be used to show stereoscopic graphics under different perspectives. The deletion and addition of the graphic may avoid the situation where the shown graphic overlaps with the object in human eyes, as exemplified above for the text box graphic, and may also achieve the animation effect of different pictures at different viewing angles and distances. In addition, the adjusting for various images described as above may achieve the desired display effect by various combinations, and the embodiment of the present disclosure is not limited herein.

As an example of a way for obtaining the image captured at the first display side, as shown in FIG. 4, the above first obtaining unit 61 may particularly comprise a camera module which is disposed at a preset position which is relatively fixed with respect to the display screen, and the image captured at the first display side is obtained by the camera module which is toward the first display side. Further, as for the above second obtaining unit 62, the spatial position of the at least one key point described as above is obtained from a pre-stored database or a pre-stored digital model of an object. Alternatively, the spatial position of the at least one key point is obtained from the received external input signals. Of course, it is also possible to obtain the spatial position of the at least one key point on the object based on image processing in a manner similar to determining the spatial position of the human eyes, and the embodiments of the present disclosure are not limited thereto.

The present disclosure further provides a transparent display device, comprising:

a processor; and

a memory for storing instructions executable by the processor;

wherein the processor is configured to:

obtain a spatial position of eyes of a viewer at a side of a display screen with respect to the display screen;

obtain a spatial position of at least one key point of an object at the other side of the display screen with respect to the display screen;

calculate a projection position of the at least one key point on the display screen with respect to the viewer's eyes in accordance with the spatial position of the viewer's eyes with respect to the display screen and the spatial position of the at least one key point with respect to the display screen; and

adjust an image displayed on the display screen in accordance with the projection position.

The processor is further configured to:

map the spatial position of the viewer's eyes with respect to the display screen, the spatial position of the at least one key point with respect to the display screen and a plane where the display screen is located into a same spatial coordinate system;

calculate an intersection position of a line connecting each of the at least one key point with the viewer's eyes and a plane where the display screen is located to obtain at least one projection point; and

transform a position of the at least one projection point in the spatial coordinate system into a position on the plane where the display screen is located, to be used as the projection position.

The processor is further configured to: capture the viewer at the side of the display screen by a camera module fixed at a preset position of the display screen to determine in the captured image the spatial position of the viewer's eyes with respect to the display screen.

The processor is further configured to: obtain a pre-stored spatial position of the at least one key point with respect to the display screen or obtain the spatial position of the at least one key point with respect to the display screen provided by a third-party device.

The processor is further configured to: adjust at least one graphic in current image in accordance with the projection position, wherein the at least one graphic is adjusted by at least one of translation, rotation, enlargement, reduction, redrawing, segmentation, deletion and addition.

It will be understood that, the transparent display device of the embodiment of the present disclosure has functions corresponding to the steps of the transparent display method shown in FIG. 1, respectively, and may have the structure of any one of the transparent display devices described as above, which will not be described here. It should be noted that the transparent display device in the present embodiment may be any product or component having a display function such as a display panel, an electronic paper, a mobile phone, a tablet computer, a television set, a notebook computer, a digital photo frame, a navigator, or the like.

It is to be noted that, in this context, relational terms such as first, second or the like are used only to distinguish one entity or operation from another entity or operation without necessarily requiring or implying that there is any such actual relationship or sequence between these entities or operations. Moreover, the term such as “comprising”, “including” or any other variant thereof is intended to encompass a non-exclusive inclusion such that processes, methods, articles or devices that include a series of elements include not only those elements but also those that are not explicitly listed, or include other elements that are inherent to such processes, methods, articles or devices. In the absence of further restriction, the element defined by the statement “including a . . . ” does not preclude the presence of additional same elements in the process, method, article, or device that includes the elements. The azimuth or positional relationship indicated by the terms “upper”, “lower” and the like is based on the azimuth or positional relationship shown in the drawings, which is only for ease of description of the present disclosure and simplification of the description, rather than indicating or implying that the device or element referred to must have a specific orientation, or must be constructed and operated in a particular orientation, and therefore cannot be construed as limiting the disclosure. The term “disposed”, “connected” or “bonding” should be broadly understood, for example, it may be a fixed connection, a detachable connection, or an integral connection; or may be a mechanical connection, and also be an electrical connection; can be directly connected, can also be indirectly connected through an intermediate medium, or can be a connectivity within two components. The specific meanings of the above terms in the present disclosure may be understood by those of ordinary skill in the art in light of specific circumstances.

In the specification of the present disclosure, a number of specific details are described. It is to be understood, however, that the embodiments of the present disclosure may be practiced without these specific details. In some instances, well-known methods, structures, and techniques have not been shown in detail so as not to obscure the understanding of this specification. Similarly, it is to be understood that the features of the present disclosure, as described above in the exemplary embodiments of the present disclosure, are sometimes grouped together into a single embodiment, figure or description thereof in order to simplify the disclosure and to assist in the understanding of one or more of the various inventive aspects.

It is to be noted that the foregoing embodiments are merely illustrative of the technical solutions of the present disclosure and are not intended to be limiting thereof. Although the present disclosure has been described in detail with reference to the foregoing embodiments, it will be understood by those of ordinary skill in the art that it is still possible to modify the technical solutions recited in each of the foregoing embodiments, or to equivalently replace some of the technical features therein. Such modifications or substitutions do not cause the essence of the corresponding technical solution to be departed from the spirit and scope of the technical solution of each embodiment, and are to be included within the scope of the specification of the present disclosure.

1.-12. (canceled)

13. A transparent display method, comprising:
obtaining a spatial position of eyes of a viewer at a side of a display screen with respect to the display screen;
obtaining a spatial position of at least one key point of an object at the other side of the display screen with respect to the display screen;
calculating a projection position of the at least one key point on the display screen with respect to the viewer's eyes in accordance with the spatial position of the viewer's eyes with respect to the display screen and the spatial position of the at least one key point with respect to the display screen; and
adjusting an image displayed on the display screen in accordance with the projection position.

14. The transparent display method of claim 13, wherein the step of calculating the projection position of the at least one key point on the display screen with respect to the viewer's eyes in accordance with the spatial position of the viewer's eyes with respect to the display screen and the spatial position of the at least one key point with respect to the display screen comprises:
mapping the spatial position of the viewer's eyes with respect to the display screen, the spatial position of the at least one key point with respect to the display screen and a plane where the display screen is located into a same spatial coordinate system;
calculating an intersection position of a line connecting each of the at least one key point with the viewer's eyes and a plane where the display screen is located to obtain at least one projection point; and
transforming a position of the at least one projection point in the spatial coordinate system into a position on the plane where the display screen is located, to be used as the projection position.

15. The transparent display method of claim 13, wherein the stop of obtaining the spatial position of eyes of the viewer at the side of the display screen with respect to the display screen comprises:
capturing the viewer at the side of the display screen by a camera module fixed at a preset position of the display screen to determine in the captured image the spatial position of the viewer's eyes with respect to the display screen.

16. The transparent display method of claim 13, wherein the step of obtaining the spatial position of the at least one key point of the object at the other side of the display screen with respect to the display screen comprises:
obtaining a pre-stored spatial position of the at least one key point with respect to the display screen or obtaining the spatial position of the at least one key point with respect to the display screen provided by a third-party device.

17. The transparent display method of claim 13, wherein the step of adjusting the image displayed on the display screen in accordance with the projection position comprises:
adjusting at least one graphic in current image in accordance with the projection position,
wherein the at least one graphic is adjusted by at least one of translation, rotation, enlargement, reduction, redrawing, segmentation, deletion and addition.

18. A transparent display device, comprising:
a processor; and
a memory for storing instructions executable by the processor;
wherein the processor is configured to:
obtain a spatial position of eyes of a viewer at a side of a display screen with respect to the display screen;
obtain a spatial position of at least one key point of an object at the other side of the display screen with respect to the display screen;
calculate a projection position of the at least one key point on the display screen with respect to the viewer's eyes in accordance with the spatial position of the viewer's eyes with respect to the display screen and the spatial position of the at least one key point with respect to the display screen; and
adjust an image displayed on the display screen in accordance with the projection position.

19. The transparent display device of claim 18, wherein the processor is further configured to:
a map the spatial position of the viewer's eyes with respect to the display screen, the spatial position of the at least one key point with respect to the display screen and a plane where the display screen is located into a same spatial coordinate system;
a calculate an intersection position of a line connecting each of the at least one key point with the viewer's eyes and a plane where the display screen is located to obtain at least one projection point; and
a transform a position of the at least one projection point in the spatial coordinate system into a position on the plane where the display screen is located, to be used as the projection position.

20. The transparent display device of claim 18, wherein the processor is further configured to:
capture the viewer at the side of the display screen by a camera module fixed at a preset position of the display screen to determine in the captured image the spatial position of the viewer's eyes with respect to the display screen.

21. The transparent display device of claim 18, wherein the processor is further configured to:
obtain a pre-stored spatial position of the at least one key point with respect to the display screen or obtain the spatial position of the at least one key point with respect to the display screen provided by a third-party device.

22. The transparent display device of claim 18, wherein the processor is further configured to:
adjust at least one graphic in current image in accordance with the projection position,
wherein the at least one graphic is adjusted by at least one of translation, rotation, enlargement, reduction, redrawing, segmentation, deletion and addition.

23. A transparent display method, comprising:
obtaining a first spatial position of eyes of a first viewer at a first side of a display screen with respect to the display screens and a second spatial position of eyes of a second viewer at the first side of the display screen with respect to the display screen;
obtaining a spatial position of at least one key point of an object at the other side of the display screen with respect to the display screen;
calculating a first projection position of the at least one key point on the display screen with respect to the first viewer's eyes in accordance with the first spatial position and the spatial position of the at least one key point with respect to the display screen, and calculating a second projection position of the at least one key point on the display screen with respect to the second viewer's eyes in accordance with the second spatial position and the spatial position of the at least one key point with respect to the display screen; and
adjusting a first image displayed for the first viewer on the display screen in accordance with the first projection position, and adjusting a second image displayed for the second viewer on the display screen in accordance with the second projection position.

24. The transparent display method of claim 23, wherein the first image and the second image are non-overlapping.

25. The transparent display method of claim 14, wherein the step of adjusting the image displayed on the display screen in accordance with the projection position comprises:
adjusting at least one graphic in current image in accordance with the projection position,
wherein the at least one graphic is adjusted by at least one of translation, rotation, enlargement, reduction, redrawing, segmentation, deletion and addition.

26. The transparent display method of claim 15, wherein the step of adjusting the image displayed on the display screen in accordance with the projection position comprises:
adjusting at least one graphic in current image in accordance with the projection position,
wherein the at least one graphic is adjusted by at least one of translation, rotation, enlargement, reduction, redrawing, segmentation, deletion and addition.

27. The transparent display method of claim 16, wherein the step of adjusting the image displayed on the display screen in accordance with the projection position comprises:
adjusting at least one graphic in current image in accordance with the projection position,
wherein the at least one graphic is adjusted by at least one of translation, rotation, enlargement, reduction, redrawing, segmentation, deletion and addition.

28. The transparent display device of claim 19, wherein the processor is further configured to:
adjust at least one graphic in current image in accordance with the projection position,
wherein the at least one graphic is adjusted by at least one of translation, rotation, enlargement, reduction, redrawing, segmentation, deletion and addition.

29. The transparent display device of claim 20, wherein the processor is further configured to:
adjust at least one graphic in current image in accordance with the projection position,
wherein the at least one graphic is adjusted by at least one of translation, rotation, enlargement, reduction, redrawing, segmentation, deletion and addition.

30. The transparent display device of claim 21, wherein the processor is further configured to:
adjust at least one graphic in current image in accordance with the projection position,
wherein the at least one graphic is adjusted by at least one of translation, rotation, enlargement, reduction, redrawing, segmentation, deletion and addition.
